(19) United States
(12) Patent Application Publication
(10) Pub. No.: US 2013/0076739 A1
(43) Pub. Date: Mar. 28, 2013

(54) METHOD AND APPARATUS FOR TRANSMITTING THREE-DIMENSIONAL IMAGE

(71) Applicant: REALTEK SEMICONDUCTOR CORP., Hsinchu (TW)

(72) Inventors: Ching-Sheng Cheng, Puli Township (TW); Chia-Wei Yu, Taipei City (TW)

(73) Assignee: REALTEK SEMICONDUCTOR CORP., Hsinchu (TW)

(21) Appl. No.: 13/628,866

(22) Filed: Sep. 27, 2012

(30) Foreign Application Priority Data
Sep. 27, 2011 (TW) 100134864

(51) Int. Cl. G06T 15/00

(52) U.S. Cl. CPC G06T 15/00
USPC 345/419

(57) ABSTRACT

A method for transmitting a three-dimensional (3D) image is provided. The 3D image is transmitted via an image transmission interface according to a 2D image data format. The method includes steps of: receiving a 2D image data and an image depth data; down-sampling the 2D image data to generate an image sampling data; and transmitting the 3D image comprising the image sampling data and at least one part of the image depth data via the image transmission interface.

This application claims the benefit of Taiwan application Serial No. 100134864, filed Sep. 27, 2011, the subject matter of which is incorporated herein by reference.

### BACKGROUND OF THE INVENTION

1. Field of the Invention

The invention relates in general to a method and apparatus for transmitting an image, and more particularly to a method and apparatus for transmitting a three-dimensional (3D) image.

2. Description of the Related Art

Referring to FIGS. 1 and 2, FIG. 1 shows a schematic diagram of transmitting a two-dimensional (2D) image; FIG. 2 shows a schematic diagram of transmitting a 3D image. An image data is transmitted via an image transmission interface. A current image transmission interface includes LVDS, Mini-LVDS, VbyOne-HS, iDP, DP or EPI, and transmits an image in an image transmission format including RGB444, YUV444 and YUV422. A 2D image display receives a 2D image data 10a in FIG. 1 to display a 2D image. A 3D image display receives a 3D image data 20 in FIG. 2 to display a 3D image. The 3D image data 20 includes a 2D image data 10a and an image depth data 10b. The image depth data 10b has a bit width the same as a bit width of the 2D image data 10a. The image transmission interface transmits the image depth data 10b after having transmitted the 2D image data 10a.

The image transmission interfaces needs to transmit the image depth data 10b besides the 2D image data 10b, and so an additional bandwidth is required in order to complete the transmission of the 3D image data. Further, since the 2D image data and the image depth data are individually transmitted at separate time points, an additional frame buffer is also required for storing the 2D image data and the image depth data received at different time points in order to complete subsequent image processing.

### SUMMARY OF THE INVENTION

The invention is directed to a method and apparatus for transmitting a three-dimensional (3D) image.

A method for transmitting a 3D image is provided by the present invention. The 3D image is transmitted via an image transmission interface according to a 2D image data format. The method includes steps of: receiving a 2D image data and an image depth data; down-sampling the 2D image data to generate an image sampling data; and transmitting the 3D image comprising the image sampling data and at least one part of the image depth data via the image transmission interface.

An apparatus for transmitting a 3D image is further provided by the present invention. The apparatus transmits the 3D image according to a 2D image data format. The apparatus includes a receiving circuit, a down-sampling circuit and a data reconstructing circuit. The receiving circuit receives a 2D image data and an image depth data. The down-sampling circuit is coupled to the receiving circuit, and down-samples the 2D image data to generate an image sampling data. The data reconstructing circuit is coupled to the down-sampling circuit, and transmits the 3D image comprising the image sampling data and at least one part of the image depth data according to a 3D image data format via the image transmission interface. A data bandwidth of the 3D image data format is the same as a data bandwidth of the 2D image data format.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of transmitting a 2D image data.

FIG. 2 is a schematic diagram of transmitting a 3D image data.

FIG. 3 is a schematic diagram of a 2D image data format RGB444.

FIG. 4 is a schematic diagram of a 2D image data format YUV444.

FIG. 5 is a schematic diagram of a 2D image data format YUV422.

FIG. 6 is a flowchart of a 3D image transmitting method according to a first embodiment of the present invention.

FIG. 7 is a schematic diagram of a 3D image data format according to the first embodiment of the present invention.

FIG. 8 is a flowchart of a 3D image transmitting method according to a second embodiment of the present invention.

FIG. 9 is a schematic diagram of a 3D image data format according to the second embodiment of the present invention.

FIG. 10 is a schematic diagram of a 10-bit 2D image data format RGB444.

FIG. 11 is a bit transmission format defined by a low-voltage differential signaling (LVDS) image transmission interface.

FIG. 12 is a flowchart of a 3D image transmitting method according to a third embodiment of the present invention.

FIG. 13 is a schematic diagram of a 3D image data format according to the third embodiment of the present invention.

FIG. 14 is a flowchart of a 3D image transmitting method according to a fourth embodiment of the present invention.

FIG. 15 is a schematic diagram of a 3D image data format according to the fourth embodiment of the present invention.

FIG. 16 is a schematic diagram of a 3D image transmitting apparatus according to the first embodiment of the present invention.

FIG. 17 is a schematic diagram of a 3D image transmitting apparatus according to the second embodiment of the present invention.

FIG. 18 is a schematic diagram of a 3D image transmitting apparatus according to the third embodiment of the present invention.

FIG. 19 is a schematic diagram of a 3D image transmitting apparatus according to the fourth embodiment of the present invention.

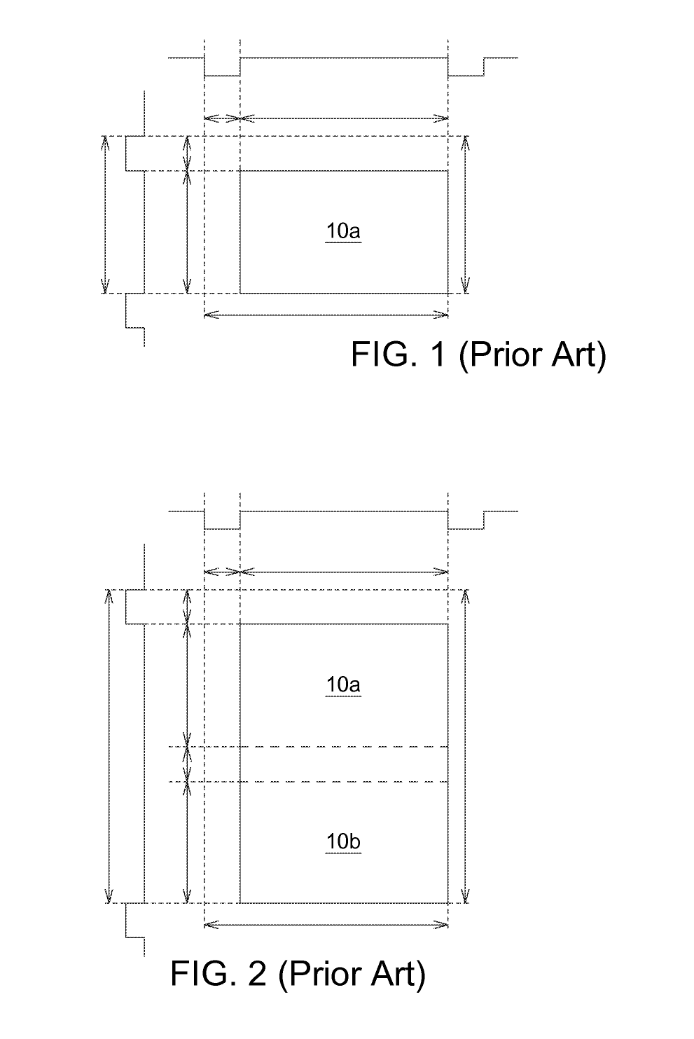

### DETAILED DESCRIPTION OF THE INVENTION

FIG. 3 shows a schematic diagram of RGB444 as an example of a 2D image data format. When an image transmission interface transmits a 2D image data, the 2D image data may be transmitted according to the 2D image data format RGB444 in FIG. 3. For example, each pixel data in a 2D image data includes a red component, a green component and a blue component. For example, a 1^{st} pixel data includes a red component R₁, a green component G₁ and a blue component B₁, a 2^{nd} pixel data includes a red component R₂, a green component G₂ and a blue component B₂, and so forth. An n^{th} pixel data includes a red component Rₙ, a green component Gₙ and a blue component Bₙ. The image transmission interface sequentially transmits the 1^{st} pixel data to the n^{th} pixel data to complete the transmission of a 2D image data 10b.

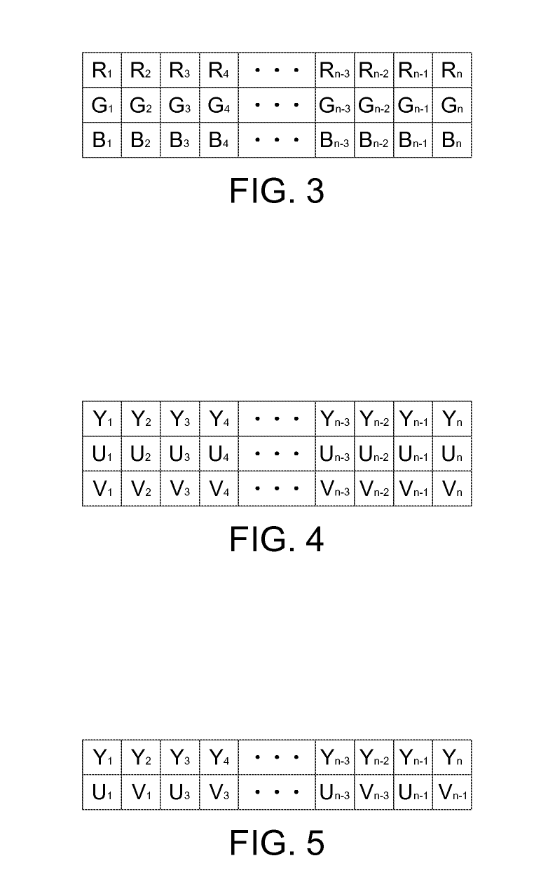

FIG. 4 shows a schematic diagram of YUV444 as an example of a 2D image data format. When an image transmission interface transmits a 2D image data, the 2D image data may also be transmitted according to the 2D image data format YUV444 in FIG. 4. For example, each pixel data in a 2D image data includes a luma component, a first chrominance component and a second chrominance component. For example, a 1^{st} pixel data includes a luma component Y₁, a first chrominance component U₁ and a second chrominance component V₁, a 2^{nd} pixel data includes a luma component Y₂, a first chrominance component U₂ and a second chrominance component V₂, and so forth. The image transmission interface sequentially transmits the 1^{st} pixel data to the n^{th} pixel data to complete the transmission of a 2D image data 10b.

FIG. 5 shows a schematic diagram of YUV422 as an example of a 2D image data format. When an image transmission interface transmits a 2D image data, the 2D image data may also be transmitted according to the 2D image data format YUV422 in FIG. 5. A main difference between YUV444 and YUV422 is that, a first chrominance component and a second chrominance component are shared by two luma components in YUV422. For example, luma components Y₁ and Y₂ share a first chrominance component U₁ and a second chrominance component V₁, and luma components Y₃ and Y₄ share a first chrominance component U₃ and a second chrominance component V₃, and so forth. That is, luma components Yₙ₋₁ and Yₙ share a first chrominance component Uₙ₋₁ and a second chrominance component Vₙ₋₁.

### First Embodiment

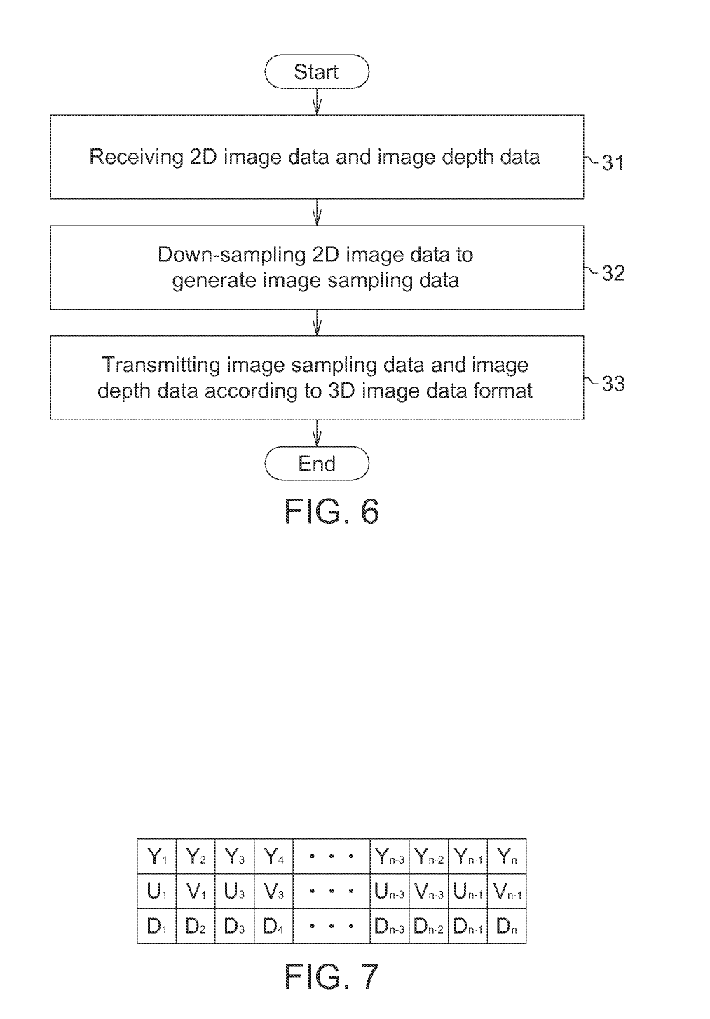

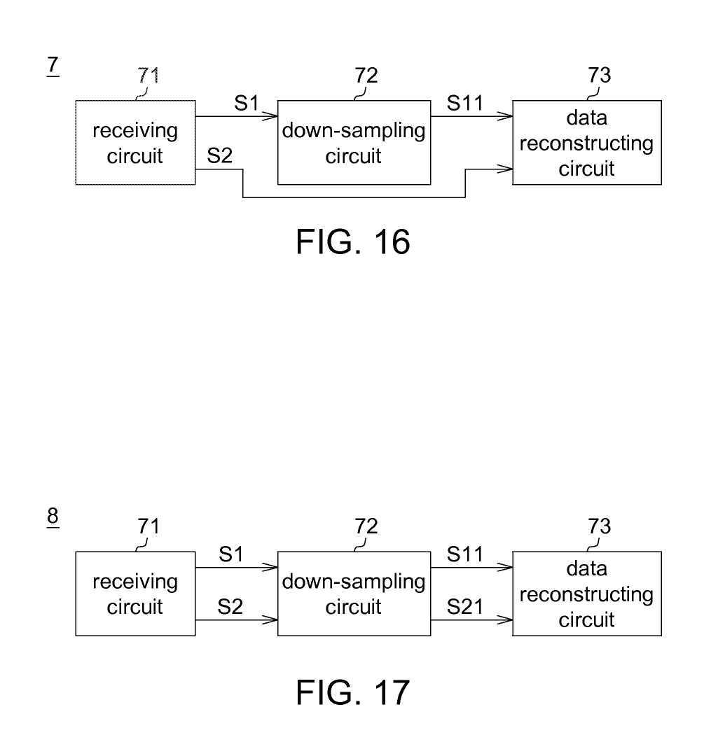

Referring to FIGS. 6, 7 and 13, FIG. 6 shows a flowchart of a 3D image transmitting method according to a first embodiment of the present invention; FIG. 7 shows a 3D image data format according to the first embodiment of the present invention; FIG. 16 shows a schematic diagram of a 3D image transmitting apparatus according to the first embodiment of the present invention. A 3D image transmitting apparatus 7 includes a receiving circuit 71, a down-sampling circuit 72 and a data reconstructing circuit 73. The 3D image transmitting apparatus 7 and the 3D image transmitting method are applied to an image transmission interface.

The method includes the following steps. In Step 31, the receiving circuit 71 receives a 2D image data S1 and an image depth data S2.

In Step 32, the down-sampling circuit 72 down-samples the 2D image data S1 to generate an image sampling data S11. In the first embodiment, YUV422 as a sampling format of the image sampling data is taken as an example. The image sampling data S11 includes luma components Y₁ to Yₙ, first chrominance components U₁, U₃, U₅ . . . to Uₙ₋₁, and second chrominance components V₁, V₃, V₅ . . . to Vₙ₋₁. The luma components Y₁ and Y₂ share the first chrominance U₁ and the second chrominance component V₁, the luma components Y₃ and Y₄ share the first chrominance U₃ and the second chrominance component V₃, and so forth. That is to say, the luma components Yₙ₋₁ and Yₙ share the first chrominance component Uₙ₋₁ and the second chrominance component Vₙ₋₁.

In a human visual system, human eyes are more sensitive to brightness changes more than to color changes. Therefore, for human eyes, the luma component is regarded as more important than the first chrominance component and the second chrominance component. By down-sampling the first chrominance component and the second chrominance component, a data transmission amount can be reduced and the data bandwidth accordingly saved can be utilized for subsequently transmitting the image depth data.

In Step 33, the data reconstructing circuit 73 transmits the image sampling data S11 and the image depth data S2 according to the 3D image data format in FIG. 7. The 3D image data format in FIG. 7 has a data bandwidth the same as a data bandwidth of the 2D image data format RGB444 in FIG. 3 or a data bandwidth of the 2D image data format YUV444 in FIG. 4. The luma components Y₁ to Yₙ are outputted via a first channel; and the first chrominance component U₁ and the second chrominance component V₁, the first chrominance component U₃ and the second chrominance component V₃, . . . , and the first chrominance component Uₙ₋₁ and the second chrominance component Vₙ₋₁ are outputted via a second channel. The image depth data D₁ to Dₙ are outputted via a third channel.

As described, in the first embodiment, 3D image transmission can be completed through the data bandwidth the same as the data bandwidth of the 2D image data format RGB444/YUV444. Therefore, the first embodiment can transmit the 3D image without requiring an additional data bandwidth. Further, the 2D image data and the image depth data can be simultaneously transmitted, and so no additional frame buffer is required to further reduce production costs.

### Second Embodiment

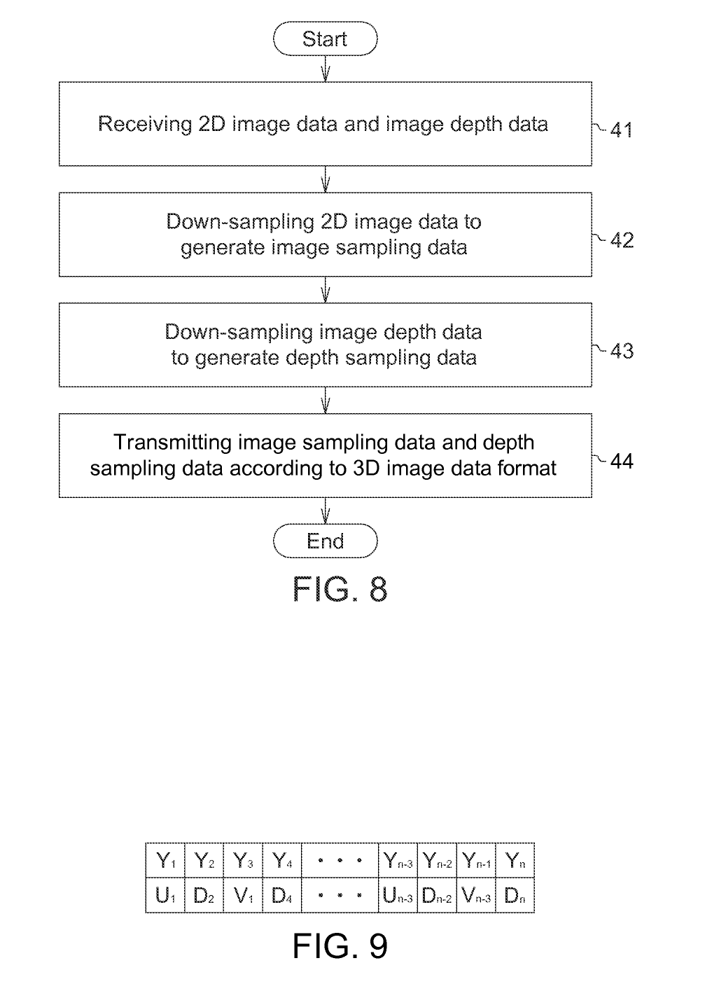

Referring to FIGS. 8, 9 and 17, FIG. 8 shows a flowchart of a 3D image transmitting method according to a second embodiment of the present invention; FIG. 9 shows a 3D image data format according to the second embodiment of the present invention; FIG. 17 shows a schematic diagram of a 3D image transmitting apparatus according to the second embodiment of the present invention. A main difference between a 3D image transmitting apparatus 8 and the 3D image transmitting apparatus 7 is that, the down-sampling 72 in the 3D image transmitting apparatus 8 further down-samples the depth image data S2 to generate a depth sampling data S21. The data reconstructing circuit 73 transmits the image sampling data S11 and the image depth data S21 according to the 3D image data format in FIG. 9. The 3D image transmitting apparatus 8 and the 3D image transmitting method are applied to an image transmission interface.

The method includes the following steps. In Step 41, the receiving circuit 71 receives the 2D image data S1 and the image depth data S2.

In Step 42, the down-sampling circuit 72 down-samples the 2D image data S1 to generate the image sampling data S11. In the second embodiment, YUV420 as a sampling format of the image sampling data is taken as an example. That is, the image sampling data S11 is a first chrominance component and a second chrominance component of a pixel sampled from every four pixels, so that a data amount of the first chrominance component and the second chrominance component of the image sampling data S11 is one-fourth of a data amount of the first chrominance component and the second chrominance component of the 2D image data S1. The image sample data S11 includes luma components Y₁ to Yₙ, first chrominance components U₁, U₅, U₉ . . . to Uₙ₋₃, and second chrominance components V₁, V₅, V₉ . . . to Vₙ₋₃. The luma components Y₁ to Y₄ share the first chrominance U₁ and the second chrominance component V₁, the luma components Y₅ to Y₈ share the first chrominance U₅ and the second chrominance component V₅, and so forth. That is to say, the luma components Yₙ₋₃ to Yₙ share the first chrominance component Uₙ₋₃ and the second chrominance component Vₙ₋₃.

In a human visual system, human eyes are more sensitive to brightness changes more than to color changes. Therefore, for human eyes, the luma component is regarded as more important than the first chrominance component and the second chrominance component. By down-sampling the first chrominance component and the second chrominance component, a data transmission amount can be reduced and the data bandwidth accordingly saved can be utilized for subsequently transmitting the image depth data.

In Step 43, the down-sampling circuit 72 down-samples the image depth data S2 to generate the depth sampling data S21. In the second embodiment, the depth sampling data S21 is a pixel sampled from every two pixels of the image depth data S2, and so a data amount of the depth sampling data S21 is one-half of a data amount of the image depth data S2. The depth sampling data S21 includes image depth data D₂, D₄ . . . and Dₙ.

In Step 44, the data reconstructing circuit 73 transmits the image sampling data S11 and the depth sampling data S21 according to the 3D image data format in FIG. 9. The 3D image data format in FIG. 9 has a data bandwidth the same as a data bandwidth of the 2D image data format YUV422 in FIG. 4. The luma components Y₁ to Yₙ are outputted via a first channel; and the first color component U₁, the image depth data D₂, the second color component V₁, the image depth data D₄, the first color component U₅, the image depth data D₆, the second color component V₅, . . . , the first color component Uₙ₋₃, the image depth data Dₙ₋₂, and the second color component Vₙ₋₃ are outputted via a second channel.

As described, in the second embodiment, 3D image transmission can be completed through the data bandwidth the same as the data bandwidth of the 2D image data format YUV422. Therefore, the second embodiment can transmit the 3D image without requiring an additional data bandwidth. Further, the 2D image data and the image depth data can be simultaneously transmitted, and so no additional frame buffer is required to further reduce production costs.

### Third Embodiment

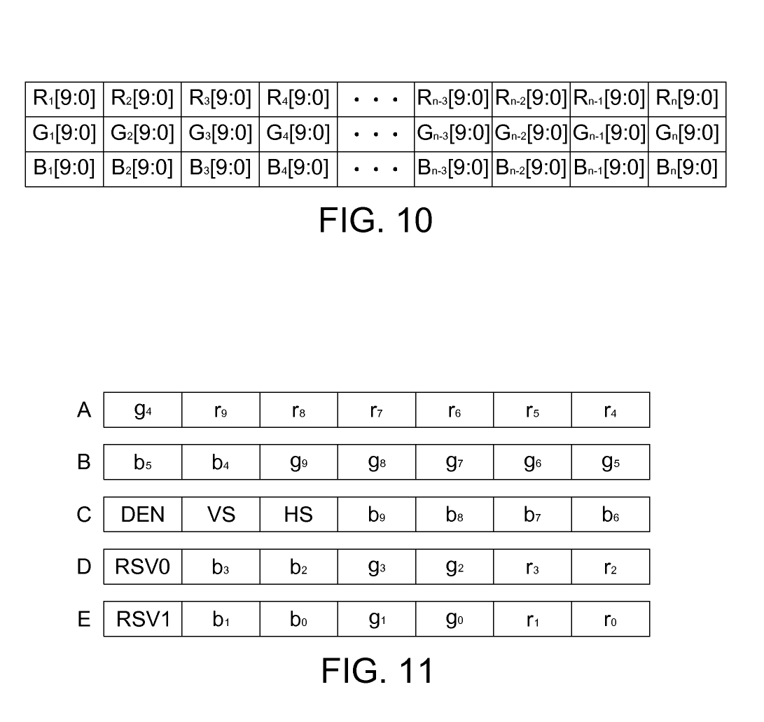

Referring to FIGS. 10 and 11, FIG. 10 shows a schematic diagram of a 10-bit 2D image format RGB444; FIG. 11 shows a schematic diagram of a bit transmission format defined by a low-voltage differential signaling (LVDS) image transmission format. When an image transmission interface transmits a 2D image data via a 10-bit LVDS image transmission interface, the 2D image data can be transmitted according to the 10-bit 2D image data format RGB444 in FIG. 10.

In FIG. 10, red components R₁[9:0] to Rₙ[9:0], green components G₁[9:0] to Gₙ[9:0], and blue components B₁[9:0] to Bₙ[9:0] are 10-bit. A 1^{st} pixel data includes the red component R₁[9:0], the green component G₁[9:0] and the blue component B₁[9:0], a next pixel data includes the red component R₂[9:0], the green component G₂[9:0] and the blue component B₂[9:0], and so forth. That is, an n^{th} pixel data includes a red component Rₙ[9:0], a green component Gₙ[9:0] and a blue component Bₙ[9:0]. The pixel data are transmitted according to a bit transmission format in FIG. 11.

The bit transmission format defined by the LVDS image transmission interface is as depicted in FIG. 11. The LVDS image transmission interface defines a reserved bit RSV0, a reserved bit RSV1, a data enable bit DEN, a vertical synchronization bit VS, a horizontal synchronization bit HS, data bits r₀ to r₉, data bits g₀ to g₉, and data bits b₀ to b₉. The data bits r₀ to r₉, the data bits g₀ to g₉, and the data bits b₀ to b₉ are for respectively transmitting the red component, the green component and the blue component in the 2D image data.

The data bit g₄ and the data bits r₄ to r₉ are transmitted via a channel A, and the data bits b₄ to b₅ and the data bits g₅ to g₉ are transmitted via a channel B. The data enable bit DEN, the vertical synchronization bit VS, the horizontal synchronization bit HS and the data bits b₆ to b₉ are transmitted via a channel C. The reserved bit RSV0, the data bits r₂ to r₃, the data bits g₂ to g₃ and the data bits b₂ to b₃ are transmitted via a channel D. The reserved bit RSV1, the data bits r₀ to r₁, the data bits g₀ to g₁ and the data bits b₀ to b₁ are transmitted via a channel E.

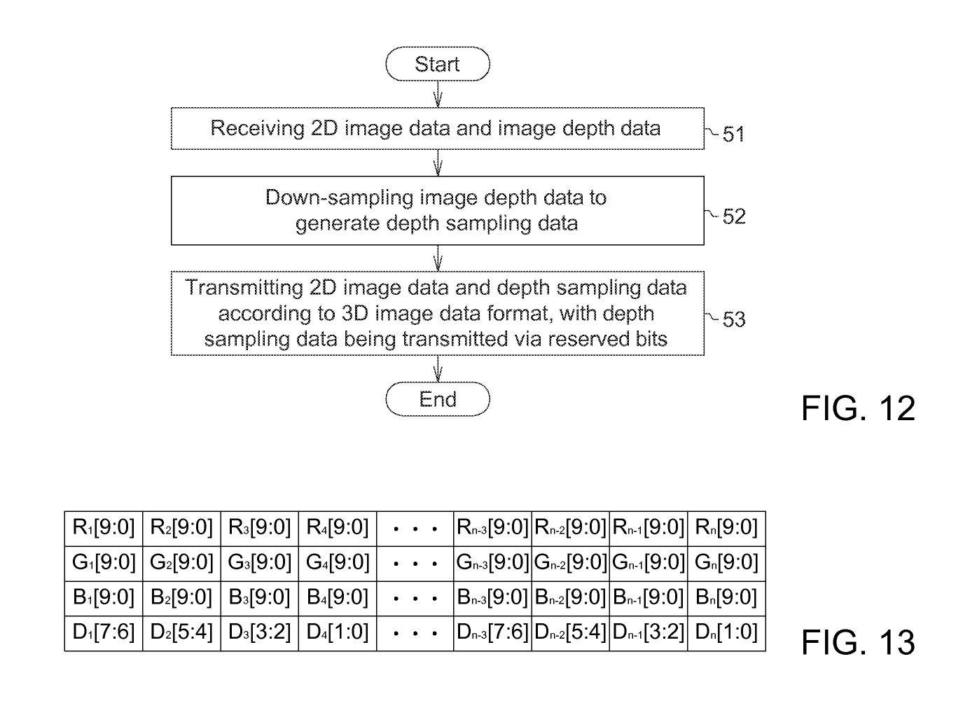

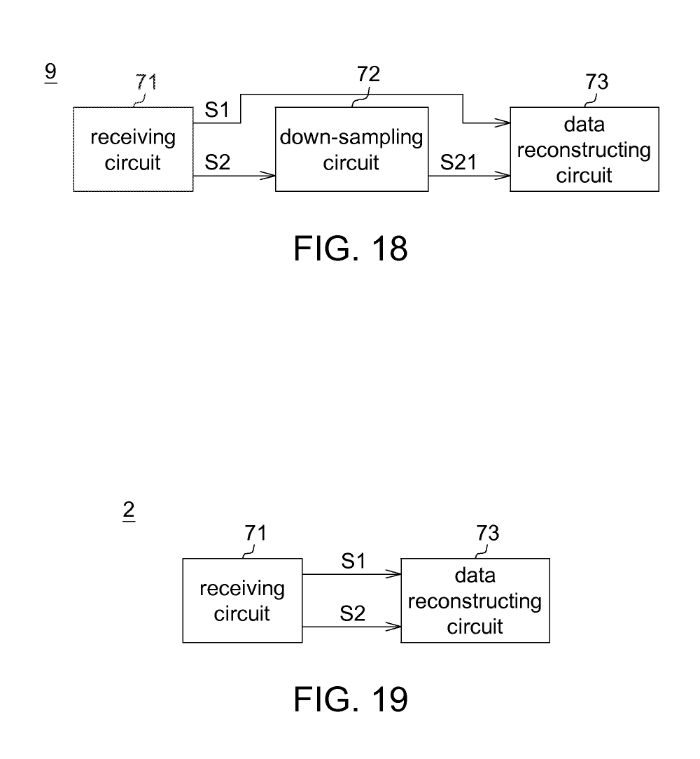

Referring to FIGS. 12, 13 and 18, FIG. 12 shows a flowchart of a 3D image transmitting method according to the third embodiment of the present invention; FIG. 13 shows a schematic diagram of a 3D image data format according to the third embodiment of the present invention; FIG. 18 shows a schematic diagram of a 3D image transmitting apparatus according to the third embodiment of the present invention. A main difference between a 3D image transmitting apparatus 9 and the 3D image transmitting apparatus 8 is that the down-sampling circuit 72 in the 3D image transmitting apparatus 9 does not down-sample the 2D image data S1. The data reconstructing circuit 73 transmits the 2D image data S1 and the image depth data S21 according to a 3D image data format in FIG. 13. The 3D image transmitting apparatus 9 and the 3D image transmitting method are applied to the foregoing LVDS image transmission interface.

The method includes the following steps. In Step 51, the receiving circuit 71 receives the 2D image data S1 and the image depth data S2. In the third embodiment, the image depth data S2 in 8-bit is taken as an example.

In Step 52, the down-sampling circuit 72 down-samples the image depth data S2 to generate the depth sampling data S21. In the third embodiment, the depth sampling data S21 is a pixel sampled from every four pixels of the image depth data S2, and so a data amount of the depth sampling data S21 is one-fourth of a data amount of the image depth data S2. The depth sampling data S21 includes the image depth data D₁, D₃, . . . , and Dₙ₋₃.

In Step 53, the data reconstructing circuit 73 transmits the 2D image data S1 and the depth sampling data S21 according to a 3D image data format in FIG. 13. The depth sampling data S21 is transmitted via the reserved bit RSV0 and the reserved bit RSV1. The 3D image data format in FIG. 13 has a data bandwidth the same as a data bandwidth of the 2D of the 10-bit 2D image data format RGB444 in FIG. 10.

For example, when transmitting the red component R₁[9:0], the green component G₁[9:0] and the blue component B₁[9:0] of the 1^{st} pixel data, the image depth data D₁[7:6] is transmitted via the reserved bit RSV0 and the reserved bit RSV1. When transmitting the red component R₂[9:0], the green component G₂[9:0] and the blue component B₂[9:0] of the 2^{nd} pixel data, the image depth data D₁[5:4] is transmitted via the reserved bit RSV0 and the reserved bit RSV1. When transmitting the red component R₃[9:0], the green component G₃[9:0] and the blue component B₃[9:0] of the 3^{rd} pixel data, the image depth data D₁[3:2] is transmitted via the reserved bit RSV0 and the reserved bit RSV1. When transmitting the red component R₄[9:0], the green component G₄[9:0] and the blue component B₄[9:0] of the 4^{th} pixel data, the image depth data D₁[1:0] is transmitted via the reserved bit RSV0 and the reserved bit RSV1. Thus, one complete image depth data is correspondingly transmitted when every four pixel data are transmitted.

As described, in the third embodiment, 3D image transmission can be completed through the data bandwidth the same as the data bandwidth of the 10-bit 2D image data format RGB444. Therefore, the third embodiment can transmit the 3D image without requiring an additional data bandwidth. Further, the 2D image data and the image depth data can be simultaneously transmitted, and so no additional frame buffer is required to further reduce production costs.

### Fourth Embodiment

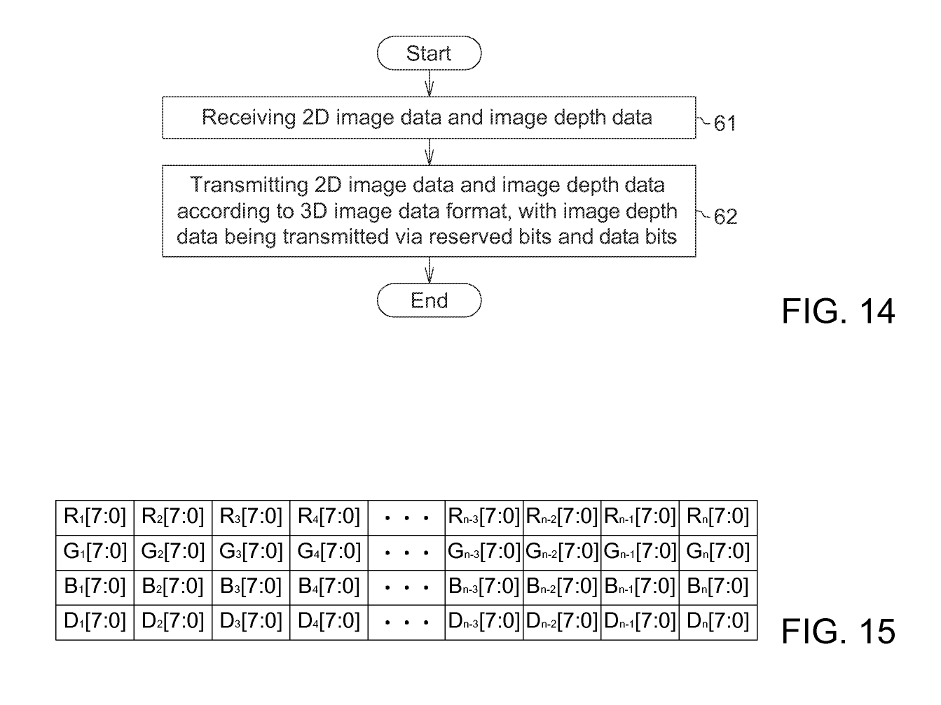

The description below is given with reference to FIGS. 10, 11, 14, 15 and 19. FIG. 14 shows a flowchart of a 3D image transmitting method according to a fourth embodiment of the present invention; FIG. 19 shows a schematic diagram of a 3D image transmitting apparatus according to the fourth embodiment of the present invention. A 3D image transmitting apparatus 2 includes a receiving circuit 71 and a data reconstructing circuit 73. The 3D image transmitting apparatus 2 and the 3D image transmitting method are applied to the foregoing LVDS image transmitting interface.

The method includes the following steps. In Step 61, the receiving circuit 71 receives the 2D image data S1 and the image depth data S2. In the fourth embodiment, an image transmitting interface is a 10-bit LVDS image transmission interface, and the 2D image data S1 and the image depth data S2 are both 8-bit. In other words, the red components R₁[7:0] to Rₙ[7:0], the green components G₁[7:0] to Gₙ[7:0], the blue components B₁[7:0] to Bₙ[7:0], and the image depth data D₁[7:0] to Dₙ[7:0] are 8-bit.

In Step 62, the data reconstructing circuit 73 transmits the 2D image data S1 and the image depth data S2 according to a 3D image data format in FIG. 15. The image depth data S2 is transmitted via the reserved bit RSV0, the reserved bit RSV1, the data bits r₀ to r₁, the data bits g₀ to g₁ and the data bits b₀ to b₁. The 3D image data format in FIG. 15 has a data bandwidth the same as a data bandwidth of the 10-bit 2D image data format RGB444 in FIG. 10.

For example, when transmitting the 1^{st} pixel data, the image depth data D₁[7:6] is transmitted via the reserved bit RSV0 and the reserved bit RSV1, the image depth data D₁[5:0] is transmitted the data bits r₀ to r₁, the data bits g₀ to g₁ and the data bits b₀ to b₁. Accordingly, when transmitting the n^{th} pixel data, the image depth data Dₙ[7:6] are transmitted via the reserved bit RSV0 and the reserved bit RSV1, and the image depth data Dₙ[5:0] is transmitted the data bits r₀ to r₁, the data bits g₀ to g₁ and the data bits b₀ to b₁.

As described, in the third embodiment, 3D image transmission can be completed through the data bandwidth the same as the data bandwidth of the image data format. Therefore, the third embodiment can transmit the 3D image without requiring an additional data bandwidth. Further, the 2D image data and the image depth data can be simultaneously transmitted, and so no additional frame buffer is required to further reduce production costs.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for transmitting a three-dimensional (3D) image via an image transmission interface according to a 2D image data format, the method comprising:
receiving a 2D image data and an image depth data;
down-sampling the 2D image data to generate an image sampling data; and
transmitting the 3D image comprising the image sampling data and at least one part of the image depth data via the image transmission interface.

2. The method according to claim 1, wherein the 2D image data format is one of YUV444, RGB444, and YUV422.

3. The method according to claim 1, wherein the image transmission interface comprises a first channel, a second channel and a third channel; the image sampling data comprises a luma component, a first chrominance component and a second chrominance component; the luma component is outputted via the first channel, the first chrominance component and the second chrominance component are outputted via the second channel, and the image depth data is outputted via the third channel.

4. The method according to claim 1, wherein the step of generating the image sampling data comprises:
down-sampling the image depth data to generate a depth sampling data;
wherein, the image transmission interface transmits the image sampling data and the depth sampling data according to a 3D image data format.

5. The method according to claim 4, wherein a data amount of the depth sampling data is one-half of a data amount of the image depth data.

6. The method according to claim 5, wherein the 2D image data comprises a first color component, a second color component and a third color component; the first color component, the second color component and the third color component are M-bit, the image depth data is (M−N)-bit; and M and N are a positive integer.

7. The method according to claim 1, wherein, the at least one part of the imaged depth data are transmitted via a plurality of reserved bits of the image transmission interface.

8. The method according to claim 1, wherein the image transmission interface is one of a low-voltage differential signaling (LVDS), Mini-LVDS, VbyOne-HS, iDP, DP and EPI interface.

9. An apparatus for transmitting a 3D image via an image transmission interface according to a 2D image data format, the apparatus comprising:
a receiving circuit, for receiving a 2D image data and an image depth data;
a down-sampling circuit, coupled to the receiving circuit, for down-sampling the 2D image data to generate an image sampling data; and
a data constructing circuit, coupled to the receiving circuit, for transmitting the 3D image comprising the image sampling data and at least one part of the image depth data via the image transmission interface.

10. The apparatus according to claim 9, wherein the image transmission interface comprises a first channel, a second channel and a third channel; the image sampling data comprises a luma component, a first chrominance component and a second chrominance component; the luma component is outputted via the first channel, the first chrominance component and the second chrominance component are outputted via the second channel, and the image depth data is outputted via the third channel.

11. The apparatus according to claim 9, wherein the down-sampling circuit further down-samples the image depth data to generate a depth sampling data.

12. The apparatus according to claim 11, wherein a data amount of the depth sampling data is one-half of a data amount of the image depth data.

13. The apparatus according to claim 9, wherein the at least one part of the imaged depth data are transmitted via a plurality of reserved bits of the image transmission interface.

14. The apparatus according to claim 9, wherein the 2D image data comprises a first color component, a second color component and a third color component; the first color component, the second color component and the third color component are M-bit, the image depth data is (M−N)-bit; and M and N are a positive integer.
